(19) United States
(12) Patent Application Publication
(10) Pub. No.: US 2007/0184379 A1
(43) Pub. Date: Aug. 9, 2007

(54) Peeling-off method and reworking method of resist film

(75) Inventors: Shigeo Ashigaki, Yamanashi-Ken (JP); Yoshihiro Kato, Yamanashi-Ken (JP); Yoshihiro Hirota, Tokyo-To (JP); Yusuke Muraki, Yamanashi-Ken (JP); Tetsu Kawasaki, Yamanashi-Ken (JP); Satoru Shimura, Yamanashi-Ken (JP)

Correspondence Address: SMITH, GAMBRELL & RUSSELL, 1850 M STREET, N.W., SUITE 800, WASHINGTON, DC, 20036, US

(73) Assignee: TOKYO ELECTRON LIMITED, MINATO-KU, TOKYO-TO, JAPAN (JP)

(21) Appl. No.: 10/591,345

(22) PCT Filed: Mar. 1, 2005
(86) PCT No.: PCT/JP05/03392

§ 371 Date: Aug. 31, 2006

(30) Foreign Application Priority Data
Mar. 1, 2004 (JP) 2004-056629

(51) Int. Cl. G03C 1/00

(52) U.S. Cl. 430/270.1

(57) ABSTRACT

A processing method of a substrate includes: a step of forming an Si—C based film and a resist film in turn on an objective film to be etched that has been formed on a substrate; a first etching step of etching the Si—C based film making use of the resist film as a mask; and a second etching step of etching the objective film to be etched making use of the resist film and the Si—C based film as a mask. The processing method further includes a peeling-off step of peeling-off the resist film at a desired timing. The peeling-off step includes a preparing step of preparing an organic solvent as a release agent, and an applying step of applying the organic solvent to the resist film.

### TECHNICAL FIELD

The present invention relates to a peeling-off method and a reworking method of a resist film that has been formed onto an Si—C based film.

### BACKGROUND ART

Recently, in forming a CMOS device, it has been requested to make thinner an antireflection film and a photo-resist film, which are used for an etching process, in order to achieve much finer structure. In particular, when an exposure apparatus with a high aperture ratio is used, it is more important to make thinner the photo-resist film.

On the other hand, when the photo-resist film is made thinner, it may become difficult to accurately conduct an etching process. The problem may be taken into consideration for example when resist-trimming technique is used for achieving finer structure about a transistor gate length. In order to solve the problem, it has been proposed to introduce a hard mask under a photo-resist film/an antireflection film (ARC: Anti Reflective Coating). When this method is adopted, pattern-transfer/resolution in the etching process is improved.

However, in the method of introducing the hard mask under the conventional ARC, the antireflective function may be not enough. In addition, the resolution and/or the lithography-process tolerance may be also not enough. For example, in a recent lithography process using ArF (whose wavelength is 193 nm) corresponding to a patterning process of a 65 nm CMOS, satisfactory resolution is not obtained.

In order to solve the above problem, it has been proposed to use an Si—C based film of a multi-layer structure having an antireflective function and a hard-mask function (see IEDM Tech, dig., P669, 2003 (document 1), by K. Babich et al., and U.S. Pat. No. 6,316,167). When the Si—C based film is used, reflection at a boarder surface thereof to the photo-resist film becomes substantially zero. That is, an extremely high-performance antireflective function may be achieved. In addition, since the Si—C based film has the multi-layer structure, the Si—C based film can have appropriate characteristics respectively corresponding to the photo-resist film and a base film. Furthermore, compared with the method of introducing the hard mask under the conventional ARC, the resolution and the lithography-process tolerance may be remarkably improved.

An etching method using the multi-layered Si—C based film is explained as follows. That is, the etching method comprises: a step of forming a multi-layered Si—C based film and a photo-resist film in turn on a predetermined objective film to be etched (base film) that has been formed on a substrate; a first etching step of etching the Si—C based film making use of the photo-resist film as a mask; and a second etching step of etching the objective film to be etched (base film) making use of the photo-resist film and the Si—C based film as a mask.

In addition, when a pattern of the photo-resist film formed on the Si—C based film is different from the desired one, the photo-resist film is peeled off and another photo-resist film is formed again. This process is called “reworking process”. In a peeling-off step of the photo-resist film in a reworking process, sulfuric acid and hydrogen peroxide aqueous solution are conventionally used in general (see Japanese Patent Laid-Open Publication No. 5-21334; and Japanese Patent Laid-Open Publication No. 6-291091).

### SUMMARY OF THE INVENTION

Through various experiments, the inventors have found a defect in the peeling-off step of the photo-resist film making use of the sulfuric acid and hydrogen peroxide aqueous solution. Specifically, the inventors have found that, when the photo-resist film having the antireflective function and the hard-mask function on the Si—C based film is peeled off making use of the sulfuric acid and hydrogen peroxide aqueous solution, the Si—C based film may also be damaged by the sulfuric acid and hydrogen peroxide aqueous solution so that the antireflective function and the hard-mask function may be deteriorated. In addition, the inventors have found that, when another photo-resist film is formed again (reworked) on the Si—C based film under such a condition, the reworked photo-resist film may peel off and/or pattern slant (collapse) thereof may be caused.

The present invention has been made in view of those problems and it is therefore an object of the present invention to provide a peeling-off method and a reworking method of a resist film, in which the resist film that has been formed on a Si—C based film, in particular on a Si—C based film having an antireflection function and a hard-mask function, can be peeled off without damaging the Si—C based film as a base film.

The present invention is a peeling-off method of a resist film on an Si—C based film that has been formed on a substrate comprising: a preparing step of preparing an organic solvent as a release agent, and an applying step of applying the organic solvent to the resist film.

According to the present invention, the resist film can be peeled off satisfactorily without causing any damage to the Si—C based film.

When the Si—C based film is a film having an antireflection function and a hard-mask function, it is preferable that the applying step is carried out without deteriorating the antireflection function and the hard-mask function of the Si—C based film.

Specifically, the organic solvent may be a thinner. Preferably, the organic solvent is an acetone-based thinner.

In addition, the applying step may be carried out by supplying the release agent onto the resist film with rotating the substrate. Alternatively, the applying step may be carried out by dipping the substrate into the release agent.

In addition, the present invention is a reworking method of a resist film comprising: a peeling-off step of peeling-off a resist film on an Si—C based film that has been formed on a substrate, and a reworking step of forming another resist film again on the Si—C based film, wherein the peeling-off step includes a preparing step of preparing an organic solvent as a release agent, and an applying step of applying the organic solvent to the resist film.

According to the present invention, the resist film can be peeled off without causing any damage to the Si—C based film, and peeling-off of the resist film after the reworking step and pattern slant thereof can be effectively prevented.

When the Si—C based film is a film having an antireflection function and a hard-mask function, it is preferable that the applying step is carried out without deteriorating the antireflection function and the hard-mask function of the Si—C based film.

Specifically, the organic solvent may be a thinner. Preferably, the organic solvent is an acetone-based thinner.

In addition, the applying step may be carried out by supplying the release agent onto the resist film with rotating the substrate. Alternatively, the applying step may be carried out by dipping the substrate into the release agent.

In addition, the present invention is a processing method of a substrate comprising: a step of forming an Si—C based film and a resist film in turn on an objective film to be etched that has been formed on a substrate; a first etching step of etching the Si—C based film making use of the resist film as a mask; a second etching step of etching the objective film to be etched making use of the resist film and the Si—C based film as a mask; and a peeling-off step of peeling-off the resist film at a desired timing; wherein the peeling-off step includes a preparing step of preparing an organic solvent as a release agent, and an applying step of applying the organic solvent to the resist film.

After the peeling-off step, a reworking step of forming another resist film again on the Si—C based film may be carried out. In this case, the peeling-off step and the reworking step may be carried out before the first etching step.

In addition, the present invention is a peeling-off apparatus for peeling-off a resist film on an Si—C based film that has been formed on a substrate comprising: a spin chuck that rotatably supports the substrate on which the resist film to be peeled off has been formed; and a nozzle that ejects an organic solvent as a release agent toward the substrate held by the spin chuck.

In addition, the present invention is a reworking apparatus of a resist film for peeling-off a resist film on an Si—C based film that has been formed on a substrate and for applying a next resist film comprising: a spin chuck that rotatably supports the substrate on which the resist film to be peeled off has been formed, an organic-solvent nozzle that ejects an organic solvent as a release agent toward the substrate held by the spin chuck, and a resist-liquid nozzle that ejects a resist liquid toward the substrate held by the spin chuck.

In addition, the present invention is a reworking apparatus of a resist film comprising: a peeling-off apparatus that peels off a resist film on an Si—C based film that has been formed on a substrate, and a resist-applying apparatus that applies a next resist film on the Si—C based film of the substrate from which the resist film has been peeled off.

### BRIEF DESCRIPTION OF THE DRAWINGS

FIG. 1 is schematic sectional views of a substrate for explanation of an etching method using an Si—C based film;

FIG. 2 is schematic sectional views of a substrate for explanation of an embodiment of a reworking method of a resist film according to the present invention;

FIG. 3 is a schematic sectional view showing an example of apparatus that may be used for a peeling-off step of a resist film;

FIG. 4 is a schematic sectional view showing a resist applying unit;

FIG. 5 is a schematic view showing a resist peeling-off system including an organic-solvent applying unit;

FIG. 6 is a schematic view for explanation of structure of a cooling unit in the resist peeling-off system of FIG. 5;

FIG. 7 is a schematic perspective view showing a resist applying/developing system including an organic-solvent applying unit;

FIG. 8 is a graph of composition and contact angle at a surface of an Si—C based film after a resist film is peeled off by a thinner or (sulfuric acid+hydrogen peroxide aqueous solution), compared with those as the resist film is deposited (as-depo);

FIG. 9 is a graph of XPS profile in a depth direction of the Si—C based film under the as-depo situation;

FIG. 10 is a graph of XPS profile in a depth direction of the Si—C based film after the resist film is peeled off by a thinner;

FIG. 11 is a graph of XPS profile in a depth direction of the Si—C based film after the resist film is peeled off by (sulfuric acid+hydrogen peroxide aqueous solution); and

FIG. 12 is SEM photographs of: a photo-resist pattern before a reworking step; a photo-resist pattern after a reworking step is carried out by means of (sulfuric acid+hydrogen peroxide aqueous solution); and a photo-resist pattern after a reworking step is carried out by means of a thinner.

### DESCRIPTION OF THE PREFERRED EMBODIMENTS

Hereinafter, with reference to the attached drawings, embodiments of the present invention will be explained specifically.

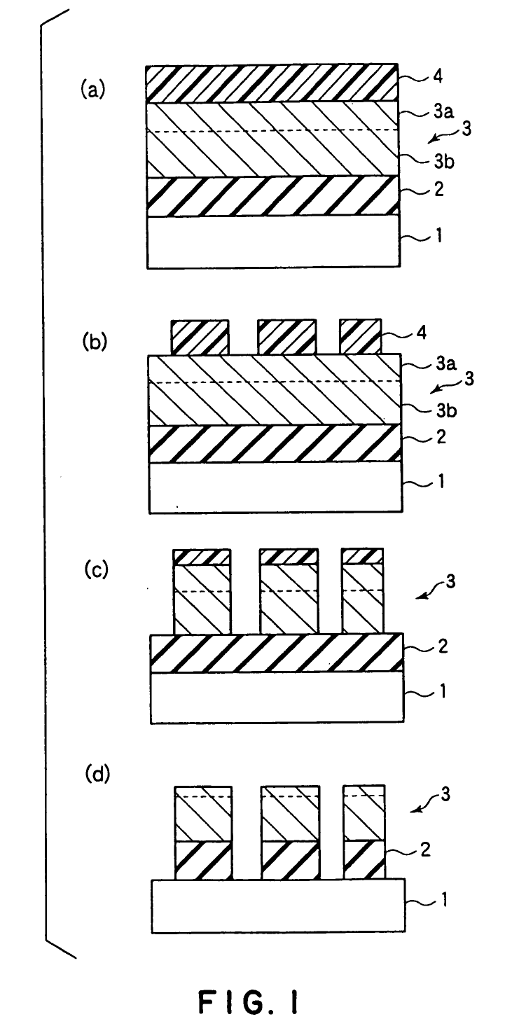

FIG. 1 shows schematic sectional views of a substrate for explanation of an etching method using an Si—C based film.

As shown in FIG. 1(a), an Si—C based film 3 is formed on an objective film to be etched 2, for example an oxide film (TEOS or a thermally oxidized film), which has been formed on a semiconductor substrate (semiconductor wafer) 1. A photo-resist film 4 is formed on the Si—C based film 3.

The Si—C based film 3 has an antireflection function and a hard-mask function. More specifically, the Si—C based film 3 is the same as that disclosed in the above document 1, which is available from IBM in the name of “TERA”. The Si—C based film 3 is a film of multi-layer structure formed by a plasma CVD process. Depending on materials of the objective film to be etched 2 and the photo-resist film 4, complex refractive index (n+ik: n is refractive index, k is extinction coefficient) of each layer for an exposure beam of a predetermined wavelength has been adjusted. For example, for the wavelength of 193 nm, the value of n in each layer is adjusted within about 1.62 to about 2.26, and the value of k in each layer is adjusted within about 0.045 to about 0.75. These values may be adjusted by changing film-forming conditions such as film-forming temperature, pressure, gas composition, and gas flow rate. For example, a double layer structure may be adopted, wherein a layer 3a (cap layer) adjacent to the photo-resist film 4 is made of SiCOH composition, a layer 3b (bottom layer) adjacent to the objective film to be etched 2 is made of SiCH composition, and the layers 3a and 3b have different n and k.

By adjusting the values of n and k and the film thickness (layer thickness), a superior antireflective function can be achieved. That is, it is possible to reduce reflectivity at a boarder surface between the Si—C based film 3 and the photo-resist film 4 to substantially zero. In addition, in a recent lithography process using ArF (whose wavelength is 193 nm) corresponding to a patterning process of a 65 nm CMOS, satisfactory resolution can be obtained. Furthermore, even in another lithography process using F2 (whose wavelength is 157 nm) and EUV corresponding to a next generation less than 65 nm, satisfactory resolution can be obtained.

In addition, since the Si—C based film 3 is an inorganic film, the Si—C based film 3 can be etched with a high selective ratio to the photo-resist film 4. On the other hand, an oxide film or the like that is the objective film to be etched 2 can be etched with a high selective ratio to the Si—C based film 3. That is, the Si—C based film 3 has a superior hard-mask function.

Then, as shown in FIG. 1(b), by a lithography step, a patterning of the photo-resist film 4 is carried out. Herein, an ArF resist film is used as the photo-resist film 4, exposed to an ArF laser beam whose wavelength is 193 nm, and developed to form a predetermined pattern.

After that, as shown in FIG. 1(c), while the photo-resist film 4 functions as a mask, the Si—C based film 3 is etched. Then, as shown in FIG. 1(d), the photo-resist film 4 and the objective film to be etched 2 are etched.

Next, an embodiment of a reworking method of a resist film according to the present invention will be explained.

At a timing before or after any of processes (steps) shown in FIG. 1, a step of peeling off the photo-resist film 4 may be carried out. Typically, when the pattern of the photo-resist film 4 is not a desired pattern under a situation wherein the photo-resist film 4 has been formed as shown in FIG. 1(b), the photo-resist film 4 is peeled off, and another photo-resist film 4′ may be formed again. Such a process is called reworking process. This process plays a very important role in manufacturing a high-definition device. In addition, the reworking process may be carried out when the application state of the photo-resist film 4 is not enough in the situation of FIG. 1(a) as well.

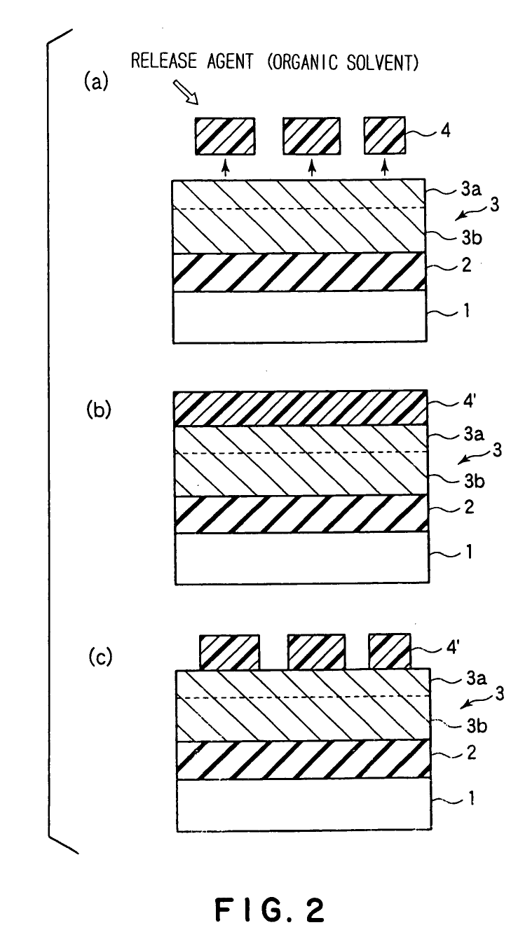

In the present embodiment, an organic solvent is used as a release agent, and the photo-resist film 4 on the Si—C based film 3 is peeled off. After the photo-resist film 4 on the Si—C based film 3 is peeled off making use of an organic solvent as a release agent as shown in FIG. 2(a), another photo-resist film 4′ is formed again as shown in FIG. 2(b) (reworking step). After that, as shown in FIG. 2(c), a patterning (pattern-forming) step is carried out by a photolithography.

Although (sulfuric acid+hydrogen peroxide aqueous solution) is conventionally often used, if (sulfuric acid+hydrogen peroxide aqueous solution) is used herein as the release agent, the Si—C based film 3 may be damaged by oxidation. In that case, pattern's slant and/or peeling-off of the resist film may be caused in the resist pattern after the reworking step. However, according to the present embodiment, since an organic solvent is used as the release agent, although the photo-resist film 4 made of an organic material is satisfactorily removed, the Si—C based film 3 made of an inorganic material is not affected thereby, so that the surface of the Si—C based film 3 is not damaged. Thus, in the photo-resist film 4′ formed by the reworking process of the present embodiment, after the pattern-forming step, pattern's slant and/or peeling-off of the resist film, which are caused by damages of the base layer, are more unlikely to be caused.

The organic solvent used as the release agent is not limited, but may be selected suitably for the material of the photo-resist film 4. Among organic solvents, a thinner is preferable. In particular, an acetone-based thinner is preferable. As a specific example, PGME (propylene glycol mono-methyl ether) or PGMEA (propylene glycol mono-methyl ether acetate) are cited.

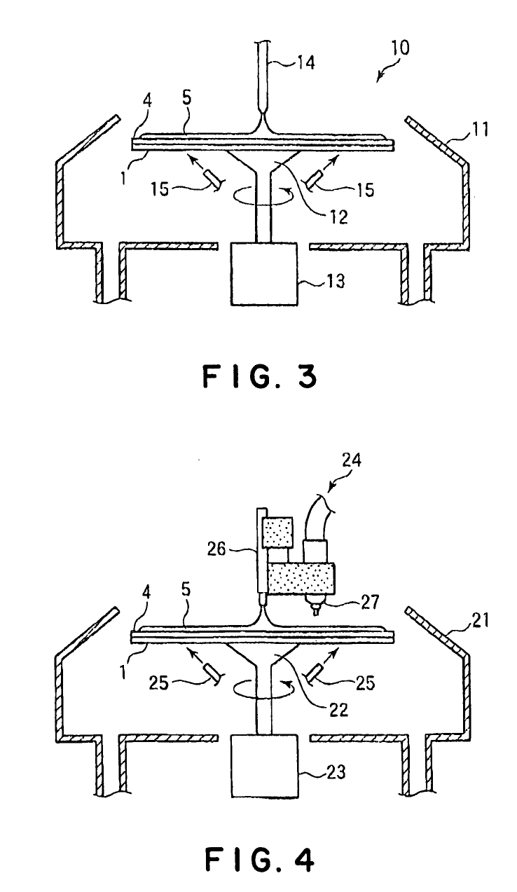

A specific manner of the step of peeling off the photo-resist film 4 by means of the release agent is not limited. For example, it is effective to eject an organic solvent as a release agent toward the photo-resist film 4 while causing the semiconductor wafer 1 on which the photo-resist film 4 has been formed to rotate. Specifically, as shown in FIG. 3, an organic-solvent applying apparatus 10 may be used, which comprises: a cup 11, a spin chuck 12 that can absorb and hold the semiconductor wafer 1 horizontally in the cup 11, a motor 13 that causes the spin chuck 12 to rotate, a nozzle 14 provided above the spin chuck 12 and capable of ejecting an organic solvent as a release agent toward a substantially central portion of the semiconductor wafer 1, and a back-rinse nozzle 15 provided under the spin chuck 12 and capable of ejecting the same release agent toward the reverse surface of the semiconductor wafer 1 in order to rinse the same.

In the case, when the photo-resist film 4 is peeled off, as shown in FIG. 3, the semiconductor wafer 1 is absorbed and supported by the spin shuck 12, and the organic solvent 5 is ejected from the nozzle 14 to the substantially central portion of the semiconductor wafer 1 while the semiconductor wafer 1 absorbed by the spin shuck 12 is rotated by the motor 13. Owing to the centrifugal force, the organic solvent 5 is applied on the whole surface of the photo-resist film 4, so that the photo-resist film 4 is dissolved and peeled off. After that, the ejection of the organic solvent 5 is stopped, so that the organic solvent in which the resist has been dissolved is cleared out. Subsequently, the organic solvent is ejected from the nozzle 14 and the back-rinse nozzle 15, so that the rinsing step of the semiconductor wafer 1 is carried out.

A concrete recipe is exemplary shown as follows. After the semiconductor wafer 1 is horizontally absorbed and held by the spin shuck 12, the nozzle 14 is positioned above the semiconductor wafer 1. Then, the semiconductor wafer 1 is rotated for 10 seconds at a rotational speed of, for example, 3000 rpm. Subsequently, the rotational speed of the semiconductor wafer 1 is decreased to, for example, 1500 rpm. Then, the organic solvent (for example, a thinner) is ejected from the nozzle 14 for 3 seconds, for example. Thus, the organic solvent is applied on the whole surface of the semiconductor wafer 1. Subsequently, under a condition wherein the rotational speed of the semiconductor wafer 1 is decreased to, for example, 40 rpm, the organic solvent is further ejected for 15 seconds, for example. Then, the ejection of the organic solvent is stopped, the nozzle is retreated, the rotational speed of the semiconductor wafer 1 is decreased to, for example, 20 rpm, and the semiconductor wafer 1 is rotated for 5 seconds. After that, the rotation of the semiconductor wafer 1 is stopped. Then, the nozzle 14 is positioned above the semiconductor wafer 1, and the semiconductor wafer 1 is rotated for 3 seconds at a rotational speed of, for example, 1500 rpm. Thus, the organic solvent is cleared out. Then, the rotation of the semiconductor wafer 1 is stopped. Subsequently, under a condition wherein the rotational speed of the semiconductor wafer 1 is adjusted to, for example, 1000 rpm, the organic solvent is ejected from the nozzle 14 and the back-rinse nozzle 15 for 5 seconds, for example. Then, the ejection of the organic solvent is stopped, the rotational speed of the semiconductor wafer 1 is increased to, for example, 2000 rpm, and the clearing-out step of the organic solvent is carried out for 8 seconds.

An organic-solvent applying apparatus 10 has substantially the same structure as a resist applying unit used for applying a photo-resist material. That is, as the organic-solvent applying apparatus 10, a resist applying unit may be used. As shown in FIG. 4, a resist applying unit comprises: a cup 21, a spin chuck 22 that can absorb and hold the semiconductor wafer 1 horizontally in the cup 21, a motor 23 that causes the spin chuck 22 to rotate, a nozzle unit 24 provided above the spin chuck 22, and a back-rinse nozzle 25 provided under the spin chuck 22. The nozzle unit 24 has a thinner nozzle 26 that ejects a thinner toward the semiconductor wafer 1 for pre-wetting before supplying a resist liquid, and a resist nozzle 27 that ejects the resist liquid. When such a resist coater is used as the organic-solvent applying unit 10 for peeling off the resist film, the photo-resist film 4 can be peeled off by ejecting the thinner from the thinner nozzle 26. On the other hand, after the photo-resist film 4 is peeled off, the resist liquid is supplied form the resist nozzle 27, so that the photo-resist material is applied and the reworking process of the photo-resist film is completed.

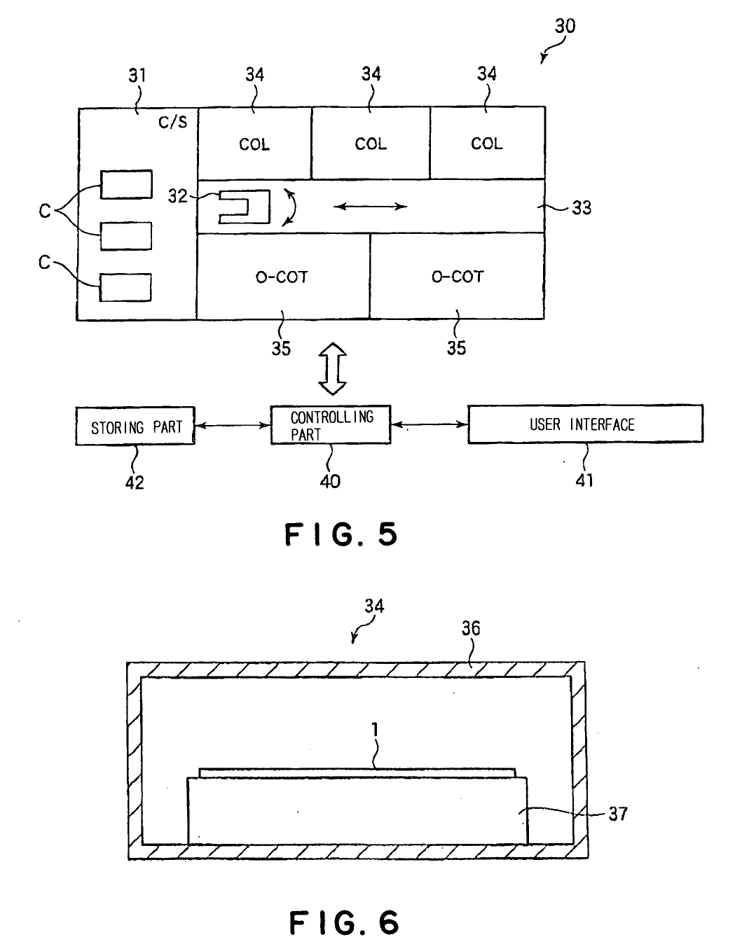

The organic-solvent applying apparatus 10 is installed in a resist peeling-off system 30 as shown in FIG. 5, for example. The resist peeling-off system 30 comprises: a carrier station (C/S) 31 in which carriers C are placed, in each of which semiconductor wafers are contained, and in which conveying-in and conveying-out operations of the semiconductor wafers are carried out; a conveying unit 32 that receives and delivers the semiconductor wafers 1 from and toward the carriers C in the carrier station (C/S) 31 and that conveys the semiconductor wafers 1; a conveying way 33 in which the conveying unit 32 is movable; three cooling units (COL) 34 provided on one side of the conveying way 33; and two organic-solvent applying units (O-COT) 35 provided on the other side of the conveying way 33. Each organic-solvent applying unit 35 is a unit into which an organic-solvent applying apparatus 10 is unitized.

As shown in FIG. 6, the cooling unit (COL) 34 consists of a housing 36 and a cooling plate 37 provided in the housing 36, a temperature of the cooling plate 37 being adjusted to, for example, 23° C. When the semiconductor wafer 1 is placed on the cooling plate 37 for a predetermined time (for example 15 seconds), a temperature of the semiconductor wafer 1 is adjusted.

In the resist peeling-off system 30, the conveying unit 32 and the other components are connected to a controlling part (process controller) 40. Then, the conveying unit 32 and the other components are adapted to be controlled by the controlling part 40. In addition, a user interface 41, such as a keyboard for a process manager to input a command or the like so as to manage/control the resist peeling-off system 30, and/or a display that visualizes and shows an operational situation of the system 30, is connected to the controlling part 40. In addition, a storing part 42 is connected to the controlling part 40. In the storing part 42, controlling programs so as to achieve various processes carried out in the resist peeling-off system 30 by controls of the controlling part 40, and/or programs/recipes so as to cause the respective components in the plasma etching apparatus to carry out the various processes according to process conditions, are stored.

The recipes may be stored in a hard disk or a semiconductor memory. Alternatively, the recipes may be set at predetermined positions in the storing part 42, in such a manner that the recipes are contained in a portable storage medium such as a CDROM or a DVD. In addition, the recipes may be transferred from another apparatus via an exclusive line, for example. When necessary, based on a certain command from the user interface 41, an optional recipe is called from the storing part 42, and is executed by the controlling part 40, so that a desired process is carried out in the resist peeling-off system 30 under a control of the controlling part 40.

In the resist peeling-off system 30, a semiconductor wafer 1, from which a photo resist film is to be peeled off, is taken out from a carrier C on the carrier station (C/S) 31 by the conveying unit 32, and is placed on the cooling plate 37 of a cooling unit (COL) 34, so that a temperature adjusting control is carried out. After that, the semiconductor wafer 1 on the cooling unit (COL) 34 is conveyed into one of organic-solvent applying units (O-COT) 35 by the conveying unit 32, so that the above peeling-off step of the photo-resist film is carried out. After the process (step) is completed, the processed semiconductor wafer 1 is delivered to the carrier C by the conveying unit 32. The above procedure is repeated by the number of semiconductor wafers 1 contained in the carrier C. Then, the semiconductor wafer from which the photo-resist film has been peeled off is conveyed into a general resist applying/developing system so as to undergo a photo-resist applying process, is subjected to a subsequent resist exposing process by an exposure apparatus connected to the resist applying/developing system, and is subjected to a subsequent developing process.

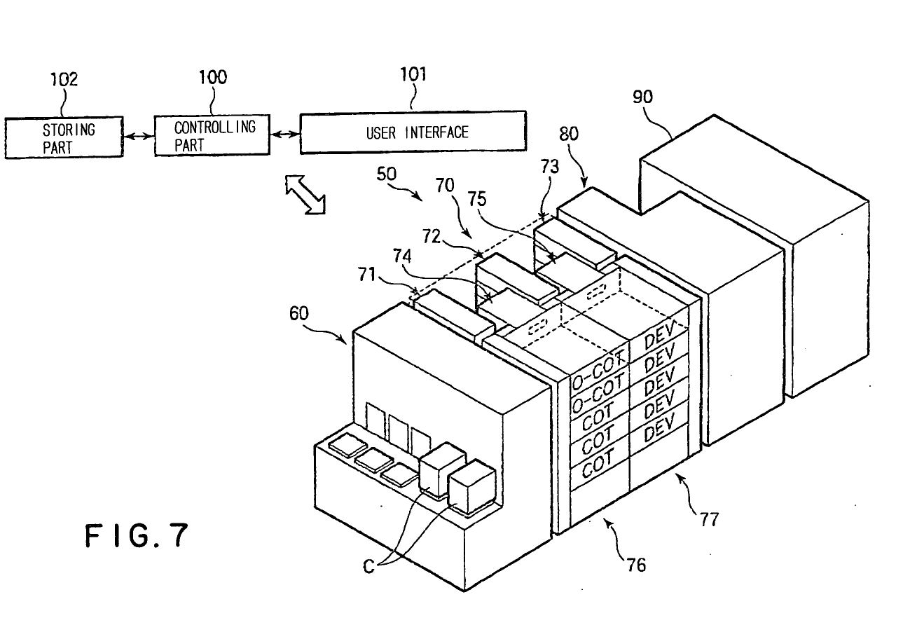

The organic-solvent applying unit that can peel off the photo-resist film, as described above, may be incorporated in a general resist applying/developing system. In that case, the reworking process of the photo-resist film can be carried out in an in-line manner. An example of resist applying/developing system including such an organic-solvent applying unit (O-COT) is explained. FIG. 7 is a perspective view showing such a resist applying/developing system 50. The resist applying/developing system 50 comprises: a carrier station 60 for receiving and delivering back carriers C each of which can contain a predetermined number of semiconductor wafers 1; a process station 70 for carrying out a resist applying process, a developing process after exposure, and thermal processes before and after them, to the semiconductor wafers; and an interface station 80 provided on the opposite side of the process station 70 to the carrier station 60 and connected to an exposure apparatus 90.

The respective components of the resist applying/developing system 50 and the exposure apparatus 90 are connected to a controlling part (process controller) 100, and thus are adapted to be controlled by the controlling part 100. In addition, a user interface 101, such as a keyboard for a process manager to input a command or the like so as to manage/control the resist applying/developing system 50 and the exposure apparatus 90, and/or a display that visualizes and shows an operational situation of the resist applying/developing system 50 and the exposure apparatus 90, is connected to the controlling part 100. In addition, a storing part 102 is connected to the controlling part 100. In the storing part 102, controlling programs so as to achieve various processes carried out in the resist applying/developing system 50 and the exposure apparatus 90 by controls of the controlling part 100, and/or programs/recipes so as to cause the respective components in the plasma etching apparatus to carry out the various processes according to process conditions, are stored.

The recipes may be stored in a hard disk or a semiconductor memory. Alternatively, the recipes may be set at predetermined positions in the storing part 102, in such a manner that the recipes are contained in a portable storage medium such as a CDROM or a DVD. In addition, the recipes may be transferred from another apparatus via an exclusive line, for example. If necessary, based on a certain command from the user interface 101, an optional recipe is called from the storing part 102, and is executed by the controlling part 100, so that a desired process is carried out in the resist applying/developing system 50 and the exposure apparatus 90 under a control of the controlling part 100.

In the process station 70, three thermal unit towers 71, 72, 73 are provided so as to sandwich two main conveyance units 74, 75 therebetween. Each of the three thermal unit towers 71, 72, 73 consists of a plurality of units piled vertically, each of which carries out a thermal process such as a heating or a cooling, associated with the resist applying/developing process. In front of the main conveyance unit 74, an applying unit tower 76 which consists of piled resist applying units (COT) and organic-solvent applying units (O-COT) is arranged. The total number of the resist applying units (COT) and the organic-solvent applying units (O-COT) is for example five. In front of the main conveyance unit 75, a developing unit tower 77 which consists of piled developing units (DEV) is arranged. The number of the developing units (DEV) is for example five. Each developing unit is adapted to carry out a developing process after the exposure. Each of the main conveyance units 74, 75 has a conveying unit that is movable in a vertical direction. Thus, the semiconductor wafers can be conveyed with respect to each of the three thermal unit towers 71, 72, 73, the applying unit tower 76 and the developing unit tower 77.

In the above resist applying/developing system 50, if a semiconductor wafer is normal and not required to be reworked, the semiconductor wafer is taken out from the carrier C by a conveying unit installed in the carrier station 60. Then, the semiconductor wafer is conveyed to a path-unit provided in the thermal unit tower 71 in the process station 70. Then, the semiconductor wafer is received by a conveying unit of the main conveyance unit 74, and is conveyed into predetermined units of the thermal unit towers 71, 72 in turn. The semiconductor wafer undergoes a temperature-adjusting process, an adhesion process, a baking process, or the like, and then is conveyed into a resist applying unit (COT) to undergo a photo-resist applying process. Then, the conveying unit of the main conveyance unit 74 takes out the semiconductor wafer from the resist applying unit (COT), and conveys it into predetermined units of the thermal unit tower 72, in turn. Then, the semiconductor wafer undergoes a baking process and a temperature-adjusting process, and is conveyed into the interface station 80 via path-units in the thermal unit towers 72, 73 by the conveying units of the main conveyance units 74, 75. In the interface station 80, a conveying unit is arranged, and a stand-by part or the like is arranged for stand-by of the semiconductor wafer. The semiconductor wafer is conveyed by the conveying unit to the exposure apparatus to undergo an exposure process. The exposed semiconductor wafer is returned to the process station 70 via the interface station 80. In the process station 70, the semiconductor wafer is conveyed into predetermined units of the thermal unit tower 73 in turn, by the conveying unit of the main conveyance unit 75, in order to undergo a post-exposure baking process and a temperature-adjusting process. Then, the semiconductor wafer is conveyed into one of the developing units (DEV). In the developing unit (DEV), a developing process of the semiconductor wafer is carried out. After that, the semiconductor wafer is conveyed into predetermined units of the thermal unit tower 72 in turn, by the conveying unit of the main conveyance unit 75, in order to undergo a baking process and a temperature-adjusting process. Then, the processed semiconductor wafer is conveyed by the conveying units of the main conveyance units 75, 74, and contained into a predetermined carrier C by the conveying unit at the carrier station 60.

If a semiconductor wafer is required to be reworked, the semiconductor wafer is conveyed from the carrier station 60 to the process station 70. In a predetermined unit of the thermal unit tower 71, the semiconductor wafer undergoes a temperature-adjusting process. Then, the semiconductor wafer is conveyed into an organic-solvent applying unit (O-COT), so that a peeling-off step of the photo-resist film is carried out. Then, the same series of processes as for a normal semiconductor wafer is carried out serially. If the organic-solvent applying unit (O-COT) can also apply the resist material, the peeling-off step of the photo-resist film and the applying step of the another photo-resist material may be carried out serially. In addition, a resist applying/developing system for processing a normal semiconductor wafer and another resist applying/developing system exclusively for reworking may be prepared separately. In that case, if a semiconductor wafer necessary to be reworked is detected by a test or the like in the resist applying/developing system for processing a normal semiconductor wafer, the semiconductor wafer is stocked in a specific carrier, and when the number of such semiconductor wafers reaches a predetermined number, such semiconductor wafers may be conveyed into the resist applying/developing system exclusively for reworking so as to undergo the reworking process.

In addition, dipping the semiconductor wafer 1 on which the photo-resist film 4 has been formed into a container filled with an organic solvent may be adopted as well.

Next, experiments carried out to confirm the effect of the present invention are explained.

Herein, a Si—C based film having a double layer structure was formed on an oxide film that has been formed on a semiconductor wafer. The Si—C based film had a layer structure consisting of a cap layer (whose thickness is 25 nm) of SiCOH composition and a bottom layer (whose thickness is 100 nm) of SiCH composition. An ArF photo-resist film was applied on the Si—C based film, and a pattern was formed in the ArF photo-resist film by means of photolithography. Then, the reworking method of the photo-resist film was carried out accordingly to the present invention.

The peeling-off step of the photo-resist film in the reworking method of the photo-resist film was carried out making use of PGME and PGMEA that are acetone-based thinners (available from TOKYO OHKA KOGYO CO., LTD.: OK82). Specifically, by means of an apparatus as shown in FIG. 3, the organic solvent was applied on the semiconductor wafer under conditions wherein the rotational speed is 1000 to 1500 rpm and the application time is 20 to 30 seconds.

As a comparison, the photo-resist film was peeled off making use of (sulfuric acid+hydrogen peroxide aqueous solution), which has been used conventionally. Specifically, a semiconductor wafer on which a photo-resist film has been formed was dipped in an aqueous solution of H₂SO₄:H₂O₂=1:12 at 120° C. for 10 minutes.

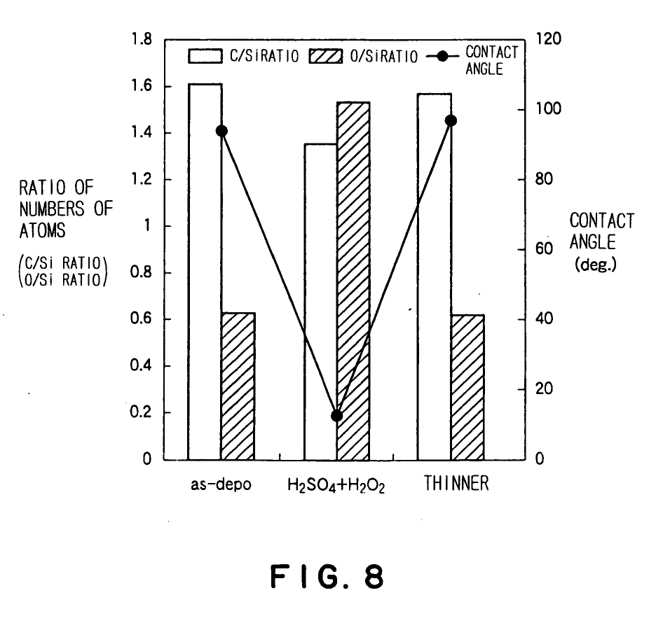

Composition and contact angle at a surface of the Si—C based film after the photo-resist film has been peeled off as described above were compared with a state wherein the photo-resist film has been deposited (as-depo). The result is shown in FIG. 8.

As shown in FIG. 8, when the (sulfuric acid+hydrogen peroxide aqueous solution) was used, compared with the “as-depo” state, the value of O/Si ratio was increased, and the contact angle was decreased. Thus, when the (sulfuric acid+hydrogen peroxide aqueous solution) is used, it has been found that oxidation of the Si—C based film is remarkably advanced, and that the Si—C based film becomes hydrophilic. That is, it has been found that the surface of the Si—C based film is damaged by the release solvent, and that the characteristics such as adhesiveness to the resist may be deteriorated.

On the other hand, as shown in FIG. 8, when a thinner as an organic solvent is used, the C/Si ratio, the O/Si ratio and the contact angle were little changed from the “as-depo” state. That is, it has been found that the surface of the Si—C based film is seldom damaged by the release solvent.

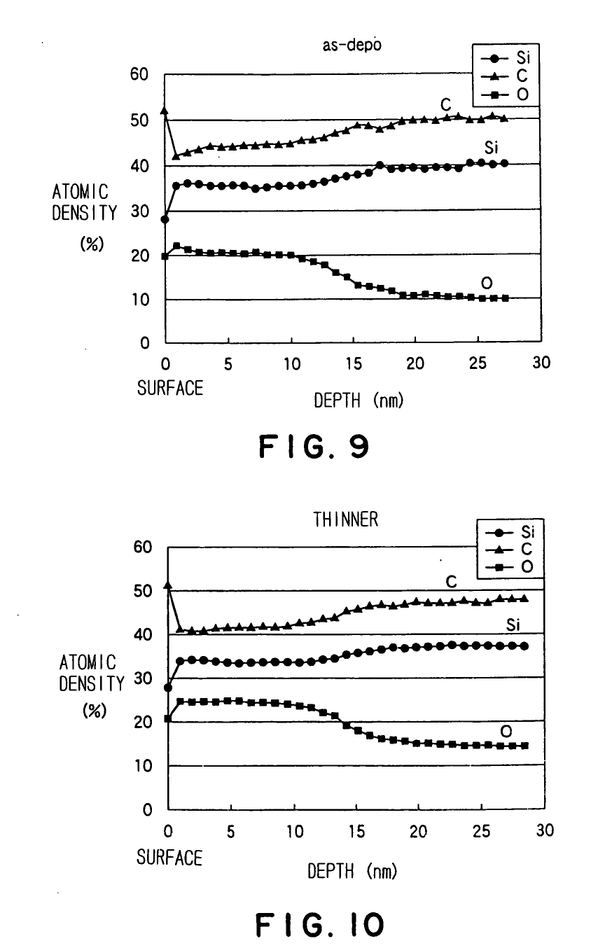

Next, by means of XPS (X-ray Photoelectron Spectroscopy), chemical composition analysis was carried out in a depth direction of each of: the Si—C based film under the “as-depo” situation; the Si—C based film after the photo-resist film has been peeled off by a thinner; and the Si—C based film after the photo-resist film has been peeled off by (sulfuric acid+hydrogen peroxide aqueous solution). These results are shown in FIGS. 9 to 11. Herein, in fact, the Si—C based film includes H, but H can not be detected by the XPS analysis method. Thus, in FIGS. 9 to 11, the ratios of component of Si, C and O, which sums up to 100%, are shown as atomic density (%) in each depth.

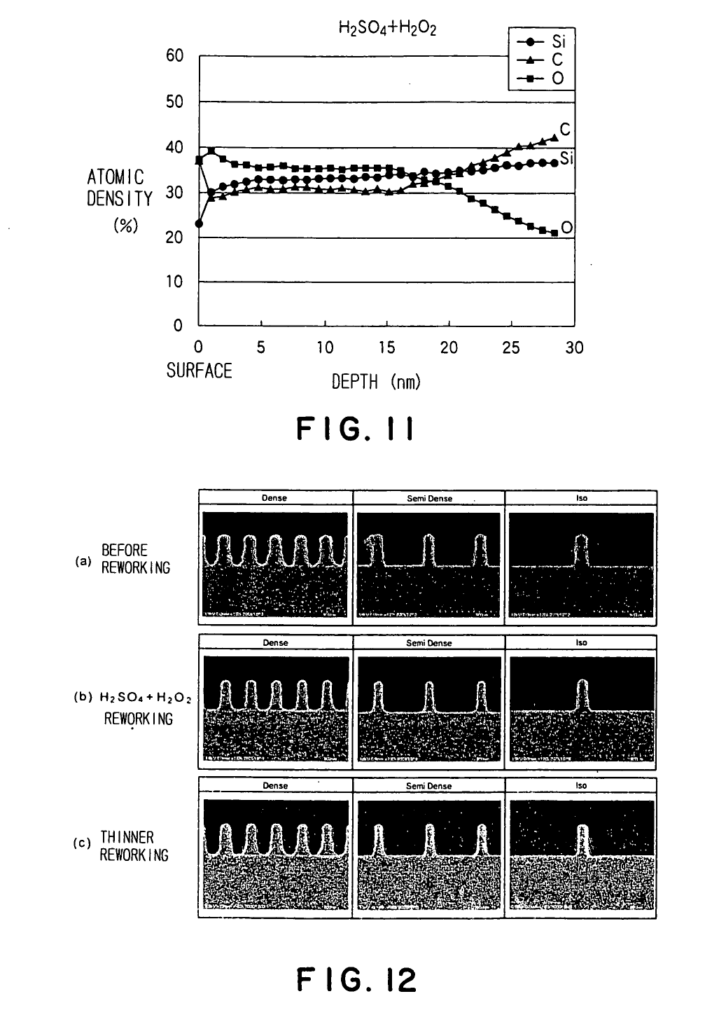

As shown in FIG. 10, when the photo-resist film was peeled off by the thinner, the composition in a depth direction was little changed. On the other hand, as shown in FIG. 11, when the photo-resist film was peeled off by the (sulfuric acid+hydrogen peroxide aqueous solution), it has been found that oxidation was advanced on the whole film.

Next, a pattern state before a reworking step (peeling-off step), a pattern state in a case wherein a reworking step has been carried out after the photo-resist film had been peeled off by the (sulfuric acid+hydrogen peroxide aqueous solution), and a pattern state in a case wherein a reworking step has been carried out after the photo-resist film had been peeled off by the thinner were compared. SEM photographs of those states are shown in FIG. 12.

As shown in FIG. 12, when a reworking step was carried out after the photo-resist film had been peeled off by the (sulfuric acid+hydrogen peroxide aqueous solution), since the base Si—C based film is damaged, particularly iso (isolated) patterns were made thinner. In addition, pattern's slant and/or peeling-off of the resist film were found. On the other hand, when a reworking step was carried out after the photo-resist film had been peeled off by the thinner, the pattern's state was as good as before the reworking step.

In addition, the present invention is not limited to the above embodiments, but may be variously modified. For example, in the above embodiment, the peeling-off of the resist film on the Si—C based film having the antireflective function and the hard-mask function has been explained. However, the present invention is not limited thereto, but also may be applied to a peeling-off of a resist film on a Si—C based film having another function. The present invention is also applicable to a peeling-off of a resist film on a low-k film of a low dielectric constant, a porous SiOC film, a SiOF film, a porous silica film or a porous MSQ film. In addition, the peeling-off step of the resist film in the reworking method has been explained mainly, but the present invention is applicable to a peeling-off step of a resist film for another purpose and/or at another timing. Furthermore, the case wherein the photo-resist film is peeled off has been explained, but the present invention is applicable to a case wherein another resist film is peeled off. Besides, the object film to be etched is not limited to the oxide film, but may be another film such as a poly-silicon film.

1. A peeling-off method of a resist film on an Si—C based film that has been formed on a substrate comprising:
a preparing step of preparing an organic solvent as a release agent, and
an applying step of applying the organic solvent to the resist film.

2. A peeling-off method of a resist film according to claim 1, wherein
the Si—C based film is a film having an antireflection function and a hard-mask function, and
the applying step is carried out without deteriorating the antireflection function and the hard-mask function of the Si—C based film.

3. A peeling-off method of a resist film according to claim 1, wherein
the organic solvent is a thinner.

4. A peeling-off method of a resist film according to claim 1, wherein
the organic solvent is an acetone-based thinner.

5. A peeling-off method of a resist film according to claim 1, wherein
the applying step is carried out by supplying the release agent onto the resist film with rotating the substrate.

6. A peeling-off method of a resist film according to claim 1, wherein
the applying step is carried out by dipping the substrate into the release agent.

7. A reworking method of a resist film comprising:
a peeling-off step of peeling-off a resist film on an Si—C based film that has been formed on a substrate, and
a reworking step of forming another resist film again on the Si—C based film,
wherein
the peeling-off step includes
a preparing step of preparing an organic solvent as a release agent, and
an applying step of applying the organic solvent to the resist film.

8. A reworking method of a resist film according to claim 7, wherein
the Si—C based film is a film having an antireflection function and a hard-mask function, and
the applying step is carried out without deteriorating the antireflection function and the hard-mask function of the Si—C based film.

9. A reworking method of a resist film according to claim 7, wherein
the organic solvent is a thinner.

10. A reworking method of a resist film according to claim 7, wherein
the organic solvent is an acetone-based thinner.

11. A reworking method of a resist film according to claim 7, wherein
the applying step is carried out by supplying the release agent onto the resist film with rotating the substrate.

12. A reworking method of a resist film according to claim 7, wherein
the applying step is carried out by dipping the substrate into the release agent.

13. A processing method of a substrate comprising:
a step of forming an Si—C based film and a resist-film in turn on an objective film to be etched that has been formed on a substrate,
a first etching step of etching the Si—C based film making use of the resist film as a mask,
a second etching step of etching the objective film to be etched making use of the resist film and the Si—C based film as a mask, and
a peeling-off step of peeling-off the resist film at a desired timing,
wherein
the peeling-off step includes
a preparing step of preparing an organic solvent as a release agent, and
an applying step of applying the organic solvent to the resist film.

14. A processing method of a substrate according to claim 13, wherein
the Si—C based film is a film having an antireflection function and a hard-mask function, and
the applying step is carried out without deteriorating the antireflection function and the hard-mask function of the Si—C based film.

15. A processing method of a substrate according to claim 13, wherein
the organic solvent is a thinner.

16. A processing method of a substrate according to claim 13, wherein
the organic solvent is an acetone-based thinner.

17. A processing method of a substrate according to claim 13, wherein
the applying step is carried out by supplying the release agent onto the resist film with rotating the substrate.

18. A processing method of a substrate according to claim 13, wherein
the applying step is carried out by dipping the substrate into the release agent.

19. A processing method of a substrate according to claim 13, wherein
after the peeling-off step, a reworking step of forming another resist film again on the Si—C based film is carried out.

20. A processing method of a substrate according to claim 19, wherein the peeling-off step and the reworking step are carried out before the first etching step.

21. A peeling-off apparatus for peeling-off a resist film on an Si—C based film that has been formed on a substrate comprising:
a spin chuck that rotatably supports the substrate on which the resist film to be peeled off has been formed, and
a nozzle that ejects an organic solvent as a release agent toward the substrate held by the spin chuck.

22. A reworking apparatus of a resist film for peeling-off a resist film on an Si—C based film that has been formed on a substrate and for applying a next resist film comprising:
a spin chuck that rotatably supports the substrate on which the resist film to be peeled off has been formed,
an organic-solvent nozzle that ejects an organic solvent as a release agent toward the substrate held by the spin chuck, and
a resist-liquid nozzle that ejects a resist liquid toward the substrate held by the spin chuck.

23. A reworking apparatus of a resist film comprising:
a peeling-off apparatus that peels off a resist film on an Si—C based film that has been formed on a substrate, and
a resist-applying apparatus that applies a next resist film on the Si—C based film of the substrate from which the resist film has been peeled off.
